(19) United States
(12) Patent Application Publication
(10) Pub. No.: US 2011/0274311 A1
(43) Pub. Date: Nov. 10, 2011

(54) SIGN LANGUAGE RECOGNITION SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/852,512

(22) Filed: Aug. 8, 2010

(30) Foreign Application Priority Data
May 4, 2010 (TW) 99114149

(51) Int. Cl. G06K 9/68; H04R 1/10; G10L 13/00

(52) U.S. Cl. 382/100; 704/260; 381/74; 382/218; 704/E13.008; 348/77

(57) ABSTRACT

A sign language recognition method includes a camera capturing an image of a gesture from a signer, comparing the image of the gesture with a number of gestures to find out the meanings of the gesture, and displaying or vocalizing the meanings of the gestures.

### BACKGROUND

1. Technical Field

The present disclosure relates to a sign language recognition system and a sign language recognition method.

2. Description of Related Art

Hearing impaired people communicate with other people with sign languages. However, people who do not know sign language find it difficult to communicate with the hearing impaired people. In addition, different countries have different sign languages, which makes communication problematic.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of a sign language recognition system.

FIG. 2 is a schematic view of a plurality of sign languages.

FIG. 3 is a schematic view of the sign language recognition system of FIG. 1.

FIG. 4 is another schematic view of the sign language recognition system of FIG. 1.

FIG. 5 is a flowchart of an exemplary embodiment of a sign language recognition method.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

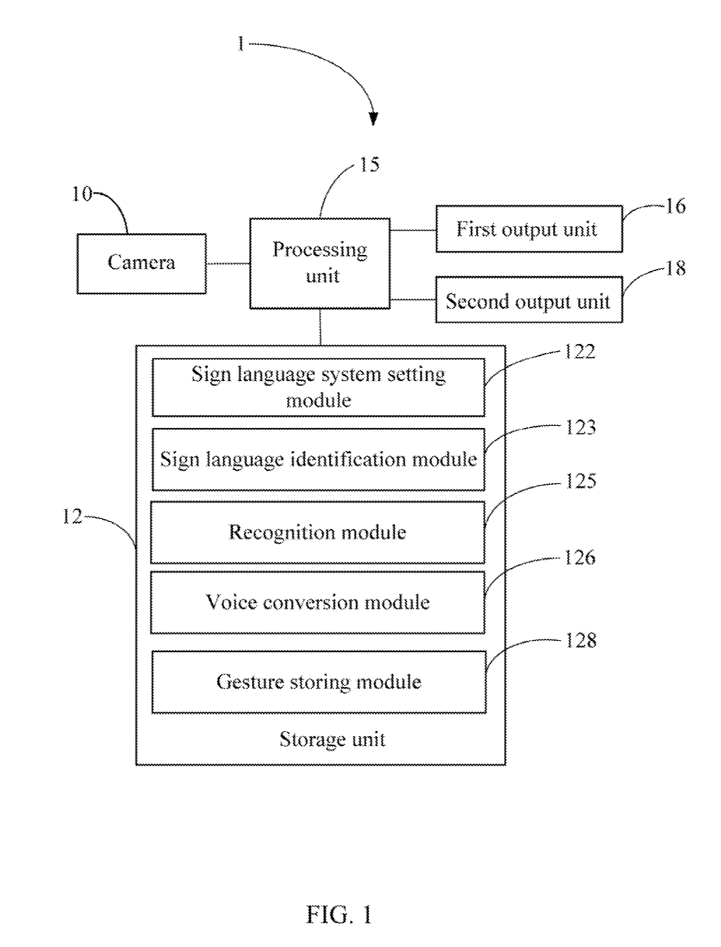

Referring to FIG. 1, an exemplary embodiment of a sign language recognition system 1 includes a camera 10, a storage unit 12, a processing unit 15, a first output unit 16, and a second output unit 18. In the embodiment, the first output unit 16 is a screen, and the second output unit 18 is a speaker or an earphone. Hereinafter the term signer is used for the person who uses sign language to communicate.

The camera 10 captures images of the gestures of a signer. The processing unit 15 and the storage unit 12 processes the images 30 captured by the camera 10, for obtaining what the signer means. The first output unit 16 displays what the signer is signing. The second output unit 18 verbalizes what the signer is signing.

The storage unit 12 includes a sign language system setting module 122, a sign language identification module 123, a recognition module 125, a voice conversion module 126, and a gesture storing module 128. The sign language system setting module 122, the sign language identification module 123, the recognition module 125, and the voice conversion module 126 may include one or more computerized instructions executed by the processor 15.

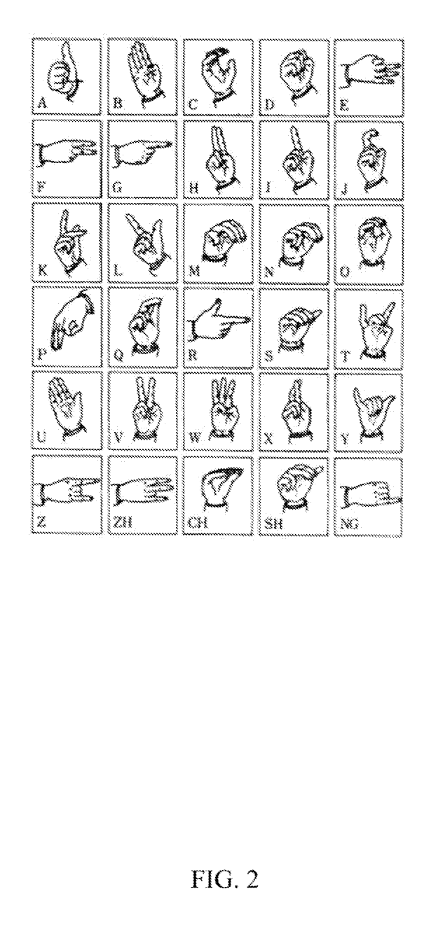

The gesture storing module 128 stores different types of gestures and meanings for each gesture as shown in FIG. 2. Each type of gestures includes a plurality of gestures. In the embodiment, the gesture storing module 128 stores two types of gestures. A first type of gestures corresponds to China Sign Language. A second type of gestures corresponds to American Sign Language. In other embodiments, the gesture storing module 128 may store more than two types of gestures or just one type of gestures.

The sign language system setting module 122 is for setting a work mode of the sign language recognition system 1. Work mode hereinafter is referring to which language of sign that the signer is using. It can be understood that in the embodiment, the work modes of the sign language recognition system 1 includes a first mode corresponding to the first type of gesture, and a second mode corresponding to the second type of gesture. In the embodiment, receivers can use two buttons to manually set the work mode of the sign language recognition system 1.

The sign language system identification module 123 is for automatically setting the work mode of the sign language recognition system 1 when the receivers do not manually set the work mode of the sign language recognition system 1. To automatically set the work mode of the sign language recognition system 1 by the sign language identification module 123 will be described as follows.

The sign language identification module 123 compares the gesture of the signer captured by the camera 10 with the plurality of types of gestures, to determine which type the gestures captured belongs to. If the gesture of the signer captured by the camera 10 belongs to the first type of gesture, the sign language identification module 123 sets the work mode of the sign language recognition system 1 as the first work mode. Moreover, if a gesture of the signer captured by the camera 10 belongs to both the first and second types of gesture, the sign language identification module 123 may compare the next gesture of the signer captured by the camera 10 with the plurality of types of gestures, until it is determined which only one type the gesture belongs to.

The recognition module 125 compares the images of the gestures captured by the camera 10 with the plurality of gestures, corresponding to the work mode of the sign language recognition system 1, to find out what the meanings of the gestures that are captured by the camera 10 are. The screen 16 displays the meanings obtained by the recognition module 125.

The voice conversion module 126 converts the gestures captured by the camera 10 into audible sounds. The speaker 18 plays the meanings of the gestures captured by the camera 10.

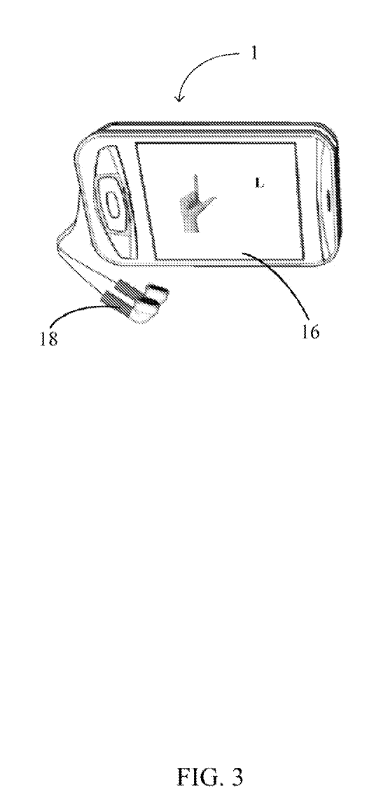

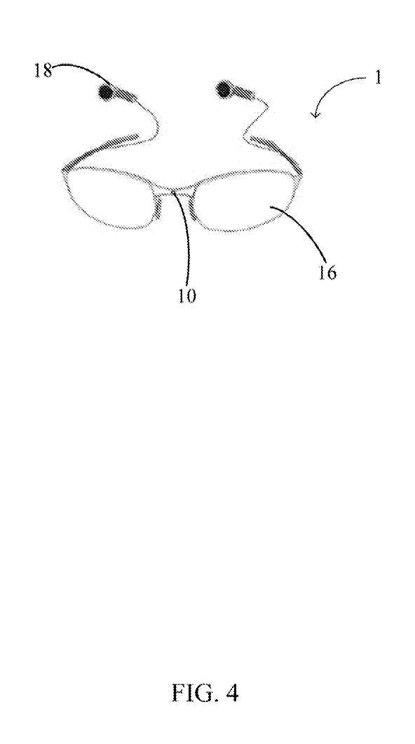

As shown in FIG. 3, the sign language recognition system 1 may be embedded within a mobile telephone. The camera 10 mounts on a surface of the body of the mobile telephone. Furthermore, the sign language recognition system 1 may take the form of glasses worn by the receiver as shown in FIG. 4. The camera 10 mounts on a bridge of the glasses.

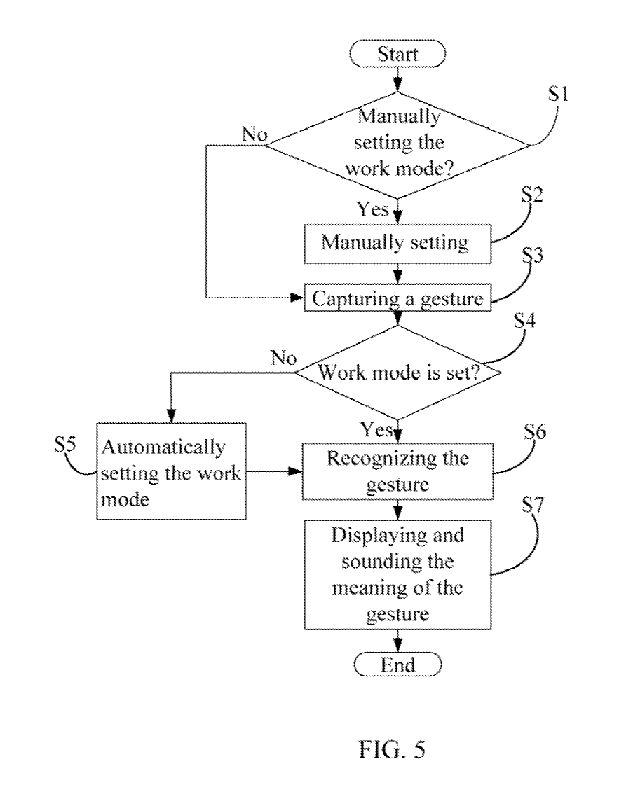

Referring to FIG. 5, an exemplary embodiment of a sign language recognition method is as follows.

In step S1, the receiver determines whether the receiver needs to manually set the work mode of the sign language recognition system 1. If the receiver needs to manually set the work mode of the sign language recognition system 1, the process flows to step S2. If the receiver does not need to manually set the work mode of the sign language recognition system 1, the process flows to step S3.

In step S2, the receiver manually sets the work mode of the sign language recognition system 1, then the process flows to step S3.

In step S3, the camera 10 captures an image of a gesture of the signer.

In step S4, the recognition module 125 determines whether the work mode is set. If the work mode is not set, the process flows to step S5. If the work mode is set, the process flows to step S6.

In step S5, the sign language identification module 123 compares the gesture of the signer captured by the camera 10 with the plurality of types of gestures, to determine which type the gesture of the signer belongs to, and sets the work mode accordingly. For example, if the gesture of the signer captured by the camera 10 belongs to the first type of gestures, the sign language identification module 123 sets the work mode of the sign language recognition system 1 as the first work mode. Moreover, if a gesture of the signer captured by the camera 10 belongs to both the first and second types of gestures, the sign language identification module 123 may compare the next gesture of the signer captured by the camera 10 with the plurality of types of gestures, until a determination is made which type the gesture belongs to.

In step S6, the recognition module 125 compares the image of the gesture captured by the camera 10 with the plurality of gestures, corresponding to the work mode of the sign language recognition system 1, to find out what meanings are associated with the gestures captured by the camera 10.

In step S7, the screen 16 displays the meanings obtained by the recognition module 125. The voice conversion module 126 converts the meanings of the gesture captured by the camera 10 into audible sounds, and the speaker 18 plays the sounds of the gesture captured by the camera 10.

The foregoing description of the embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A sign language recognition system comprising:
a camera to capture an image of a gesture of a signer;
a processing unit;
a storage unit connected to the processing unit and the camera, and storing a plurality of programs to be executed by the processing unit, wherein the storage unit comprises:
a gesture storing module storing a plurality of gestures and meanings for each gesture; and
a recognition module to compare the image of the gesture captured by the camera with the plurality of gestures, to find out the meanings of the gesture; and
an output unit connected to the processing unit, to output the meanings of the gesture.

2. The system of claim 1, wherein the plurality of gestures stored in the gesture storing module comprises a plurality of types of gestures, each type of gestures corresponds to a work mode, and comprises a plurality of gestures; the storage unit further comprises a sign language system setting module to manually set the work mode, and the recognition module compares the image of the gesture captured by the camera with the plurality of gestures belonged to a type of gestures corresponding to the work mode, to find out the meanings of the gesture.

3. The system of claim 1, wherein the plurality of gestures stored in the gesture storing module comprises a plurality of types of gestures, each type of gestures corresponds to a work mode, and comprises a plurality of gestures; the storage unit further comprises a sign language identification module to compare the gesture of the signer captured by the camera with the plurality of types of gestures, to determine which type the gesture of the signer belongs to, and correspondingly set the work mode; the recognition module compares the image of the gesture captured by the camera with the plurality of gestures belonged to one type of gestures corresponding to the work mode, to find out the meanings of the gesture.

4. The system of claim 3, wherein if a gesture of the signer captured by the camera belongs to two or more types of gestures, the sign language identification module then compares a next gesture of the signer captured by the camera with the plurality of types of gestures, to determine which type the gesture belongs to.

5. The system of claim 1, wherein the output unit is a screen to display the meanings of the gesture captured by the camera.

6. The system of claim 1, wherein the storage unit further comprises a voice conversion module to convert the meanings of the gesture captured by the camera into audible sounds; the output unit is a speaker to play the meanings of the gesture captured by the camera.

7. The system of claim 1, wherein the storage unit further comprises a voice conversion module to convert the meanings of the gesture captured by the camera into audible sounds; the output unit is an earphone to play the meanings of the gesture captured by the camera.

8. A sign language recognition method comprising:
capturing an image of a gesture of a signer by a camera;
comparing the image of the gesture with a plurality of gestures to find out the meanings of the gesture; and
outputting the meanings of the gesture.

9. The method of claim 8, wherein between the step “capturing an image of a gesture of a signer by a camera” and the step “comparing the image of the gesture with a plurality of gestures to find out the meanings of the gesture”, further comprises:
determining whether needs to set a work mode manually;
setting the work mode manually upon the condition that the work mode needs to be set manually.

10. The method of claim 9, further comprising:
comparing the gesture of the signer captured by the camera with a plurality of types of gestures, to determine which type the gesture of the signer belongs to, and correspondingly set the work mode, upon the condition that the work mode does not need to be set manually.

11. The method of claim 9, wherein the step “outputting the meanings of the gesture” comprises:
displaying the meanings of the gesture by a screen.

12. The method of claim 9, wherein the step “outputting the meanings of the gesture” comprises:
outputting the meanings of the gesture by a speaker or an earphone.
